(19) United States
(12) Patent Application Publication
(10) Pub. No.: US 2026/0350096 A1
(43) Pub. Date: Nov. 5, 2026

(54) QUESTION FRAMING EVALUATION USING A VECTOR DATABASE

(71) Applicant: INTERNATIONAL BUSINESS MACHINES CORPORATION, ARMONK, NY (US)

(72) Inventors: Dheeraj Arremsetty, Manor, TX (US); Vyoma Gajjar, San Jose, CA (US); Daniel Scott Fleck, Raleigh, NC (US); Ravikumar Govindan, Wildwood, MO (US); Krysten Thompson, Belmont, CA (US)

(21) Appl. No.: 19/084,840

(22) Filed: Mar. 20, 2025

(51) Int. Cl. G06F 16/903; G06F 16/93; G06F 40/289; G06F 40/40

(52) U.S. Cl. CPC G06F 16/90335; G06F 16/93; G06F 40/289; G06F 40/40

(57) ABSTRACT

A method, computer program product, and computer system for question framing evaluation using a vector database. A question is received. A prompt is generated from the question. The prompt, which may be enhanced via RAG or agentic RAG, is converted to an embedding. N embeddings which are closest to the embedding of the prompt are retrieved from the vector database. N is at least 2. The vector database includes multiple embeddings converted from multiple sample questions generated from document chunks by a language model. Each embedding is an embedding of a question relating to a chunk of multiple chunks of one or more documents. N closeness metrics are calculated. Each closeness metric is a measure of a closeness of the prompt to a respective question associated with each embedding. A closeness metric score equal to an average of the N closeness metrics is computed.

### BACKGROUND

The present invention relates to question framing, and more specifically, to question framing evaluation using a vector database.

### SUMMARY

First embodiments of the present invention provide a method, a computer program product, and a computer system, for question framing evaluation using a vector database. One or more processors of a computer system receive a question. The one or more processors generate a prompt from the question. The one or more processors convert the prompt to an embedding. The one or more processors retrieve, from the vector database, N embeddings which are closest to the embedding of the prompt, wherein N is at least 2, wherein the vector database includes multiple embeddings, and wherein each embedding of the multiple embeddings in the vector database is an embedding of a question relating to a chunk of multiple chunks of one or more documents. The one or more processors calculate N closeness metrics, wherein each closeness metric is a measure of a closeness of the prompt to a respective question associated with each embedding of the N embeddings. The one or more processors compute a closeness metric score equal to an average of the N closeness metrics.

Second embodiments of the present invention provide a method, a computer program product, and a computer system, for question framing evaluation using a vector database. One or more processors of a computer system split one or more documents into multiple chunks. The one or more processors input the multiple chunks into a language model. The one or more processors generate, by the language model from the multiple chunks, multiple sample questions. The one or more processors convert the multiple sample questions into respective embeddings to generate multiple embeddings. The one or more processors store the multiple embeddings in the vector database. The one or more processors receive a question. The one or more processors generate a prompt from the question. The one or more processors convert the prompt to an embedding. The one or more processors modify the prompt by a Retrieval Augmented Generation (RAG) or an agentic RAG. The one or more processors retrieve, from the vector database, N embeddings which are closest to the embedding of the modified prompt, wherein N is at least 2, wherein the vector database includes multiple embeddings, and wherein each embedding of the multiple embeddings in the vector database is an embedding of a question relating to a chunk of multiple chunks of one or more documents. The one or more processors calculate N closeness metrics, wherein each closeness metric is a measure of a closeness of the modified prompt to a respective question associated with each embedding of the N embeddings. The one or more processors compute a closeness metric score equal to an average of the N closeness metrics.

### BRIEF DESCRIPTION OF THE DRAWINGS

FIG. 1 is a flow chart of a first embodiment of a method for question framing evaluation using a vector database, in accordance with embodiments of the present invention.

FIG. 2 is a flow chart of a second embodiment of a method for question framing evaluation using a vector database, in accordance with embodiments of the present invention.

FIG. 3 is a flow chart of a process for populating the vector database with the multiple embeddings, in accordance with embodiments of the present invention.

FIG. 4A depicts a first computer architecture for implementing the method of FIGS. 1 and 2, in accordance with embodiments of the present invention.

FIG. 4B depicts a second computer architecture for implementing the method of FIGS. 1 and 2, in accordance with embodiments of the present invention.

FIG. 5 illustrates a computer system, in accordance with embodiments of the present invention.

FIG. 6 depicts a computing environment which contains an example of an environment for the execution of at least some of the computer code involved in performing the inventive methods, in accordance with embodiments of the present invention.

### DETAILED DESCRIPTION

According to a first embodiment of the invention, one or more processors of a computer system receive a question. The one or more processors generate a prompt from the question. The one or more processors convert the prompt to an embedding. The one or more processors retrieve, from the vector database, N embeddings which are closest to the embedding of the prompt, wherein N is at least 2, wherein the vector database includes multiple embeddings, and wherein each embedding of the multiple embeddings in the vector database is an embedding of a question relating to a chunk of multiple chunks of one or more documents. The one or more processors calculate N closeness metrics, wherein each closeness metric is a measure of a closeness of the prompt to a respective question associated with each embedding of the N embeddings. The one or more processors compute a closeness metric score equal to an average of the N closeness metrics.

The preceding first embodiment of the invention provides a technical feature of a closeness metric score used to evaluate a quality of the question in a manner that communicates an extent to which the question is sufficiently well formed for retrieving accurate information from the vector database for exposing a coverage of the user's question with respect to underlying datasets.

According to a first aspect of the first embodiment, the prompt is modified via one or more artificial intelligence (AI) agents of an agentic Retrieval Augmented Generation (RAG) analyzing the multiple embeddings in the vector database in relation to the question to determine contextual content relating to the question and modifying the prompt based on the contextual content.

The preceding first aspect of the first embodiment advantageously enables the AI agents to determine which embeddings in the vector database to use for extracting contextual content to add to the prompt to improving a relevance of the prompt with respect to the received question.

According to a second aspect of the first embodiment, after said computing the closeness metric, ascertaining, by the one or more processors, whether a closeness criteria is satisfied, wherein the closeness criteria comprises the closeness metric score being equal to or greater than a specified closeness metric score threshold; if said ascertaining ascertains that the closeness criteria is satisfied, then inputting, by the one or more processors, the prompt to a language model followed by the language model determining and outputting, using the one or more processors, a response to the prompt; if said ascertaining ascertains that the closeness criteria is not satisfied then exiting the method or performing an iterative process in which each iteration of the iterative process comprises: executing said modifying the prompt, said retrieving the N embeddings, said calculating the N closeness metrics, said computing the closeness metric score, and said ascertaining, wherein the iterative process ends in response to either ascertaining that the closeness metric is satisfied or a specified maximum number of iterations has been performed.

The preceding second aspect of the first embodiment advantageously provides a feedback loop, based on the closeness metric score, that enables modification of the prompt in a manner that improves the prompt, leading to more accurate and relevant responses to the modified prompt by the language model.

According to a third aspect of the first embodiment, the closeness criteria further comprises a variance of the N closeness metrics being less than a specified closeness metric variance threshold.

The preceding third aspect of the first embodiment advantageously requires that a necessary condition for the prompt to be considered sufficiently accurate to warrant being inputted to the language model is that the N closeness metric scores have sufficiently low variance.

According to a fourth aspect of the first embodiment, prior to said receiving the question, populating, by the one or more processors, the vector database with the multiple embeddings, wherein said populating the vector database comprises: splitting the one or more documents into the multiple chunks; inputting the multiple chunks into a language model; generating, by the language model from the multiple chunks, multiple sample questions; converting the multiple sample questions into respective embeddings to generate the multiple embeddings; and storing the multiple embeddings in the vector database.

The preceding fourth aspect of the first embodiment advantageously generates, with intelligence via use of the language model, embeddings as document chunks that populate the vector database to provide contextual content that can be used to modify the prompt to improve the accuracy and relevance of the prompt that is subsequently inputted to a language model for generating a response to the question.

According to a fifth aspect of the first embodiment, each chunk of each document is text selected from the group consisting of one or more paragraphs, one or more pages, one or more sections, one or more sentences, or a combination thereof, of said each document.

The preceding fifth aspect of the first embodiment advantageously enables a wide range of diverse types of document chunks to be used for flexibly providing a respective wide range of different contexts to be added to the prompt associated with the question.

According to a second embodiment of the invention, one or more processors of a computer system split one or more documents into multiple chunks. The one or more processors input the multiple chunks into a language model. The one or more processors generate, by the language model from the multiple chunks, multiple sample questions. The one or more processors convert the multiple sample questions into respective embeddings to generate multiple embeddings. The one or more processors store the multiple embeddings in the vector database. The one or more processors receive a question. The one or more processors generate a prompt from the question. The one or more processors convert the prompt to an embedding. The one or more processors modify the prompt by a Retrieval Augmented Generation (RAG) or an agentic RAG. The one or more processors retrieve, from the vector database, N embeddings which are closest to the embedding of the modified prompt, wherein N is at least 2, wherein the vector database includes multiple embeddings, and wherein each embedding of the multiple embeddings in the vector database is an embedding of a question relating to a chunk of multiple chunks of one or more documents. The one or more processors calculate N closeness metrics, wherein each closeness metric is a measure of a closeness of the modified prompt to a respective question associated with each embedding of the N embeddings. The one or more processors compute a closeness metric score equal to an average of the N closeness metrics.

The preceding second embodiment of the invention provides a technical feature of generating, with intelligence via use of the language model, embeddings as document chunks that populate the vector database to provide contextual content that can be used to modify the prompt to improve the accuracy and relevance of the prompt that is subsequently inputted to a language model for generating a response to the question. In addition, the prompt is advantageously modified by RAG or agentic RAG to provide and enhance the context that is added to the prompt. In addition, a closeness metric score is advantageously used to evaluate a quality of the question in a manner that communicates an extent to which the question is sufficiently well formed for retrieving accurate information from the vector database for exposing a coverage of the user's question with respect to underlying datasets.

According to a first aspect of the second embodiment, said modifying the prompt comprises modifying the prompt by one or more artificial intelligence (AI) agents of the agentic RAG via the one or more AI agents analyzing the multiple embeddings in the vector database in relation to the question to determine contextual content relating to the question and modifying the prompt based on the contextual content.

The preceding first aspect of the second embodiment advantageously uses AI agents of the agentic RAG to analyze the multiple embeddings in the vector database in relation to the question to determine contextual content relating to the question and to modify the prompt based on the contextual content.

According to a second aspect of the second embodiment, said modifying the prompt comprises modifying the prompt by RAG via identifying a specialized database, obtaining from the specialized database information on a particular subject which is relevant to the question, and using the information to modify the prompt.

The preceding second aspect of the second embodiment advantageously uses RAG to identify a specialized database, obtain from the specialized database information on a particular subject which is relevant to the question, and use the information to modify the prompt, which beneficially expands a scope of sources of contextual information for use in modifying the prompt associated with the question.

According to a third aspect of the second embodiment, the language model is a large language model (LLM).

The preceding third aspect of the second embodiment advantageously provides large amounts of document chunks from which to generate embeddings to populate the vector database in order to determine relevant context to add to the prompt associated with the question.

According to a fourth aspect of the second embodiment, the method further comprises: inputting, by the one or more processors, the modified prompt to a language model; and determining and outputting, by the language model using the one or more processors, a response to the prompt, said response based on the modified prompt.

The preceding fourth aspect of the second embodiment advantageously provides a response to the question based on an improved prompt that was modified based on contextual content.

Large Language Models (LLMs) have seen significant advancements, leading to widespread implementation of LLMs across various enterprises. A prominent and practical use case of LLM models is Retrieval Argument Generation (RAG), where a challenge lies in effectively framing questions to retrieve relevant information from a vector database. Despite numerous attempts to optimize RAG systems and devise metrics for evaluating performance of RAG systems, an important aspect of question framing remains a challenge.

In RAG systems, the vector database stores embeddings, and when a user frames a question, the system retrieves the closest related embeddings as context to generate a response. The accuracy and effectiveness of the response heavily depend on the quality of the embeddings extracted from the vector database. However, there is currently a lack of mechanisms for end-users to determine whether the questions framed by the user are optimal for retrieving accurate information.

Embodiments of the present invention address this lack of mechanisms by providing a novel scoring mechanism for evaluating an effectiveness of framed questions in RAG systems. The novel scoring system generates, in one embodiment, a score ranging from 0 to 1, where a score closer to 1 indicates a well-formed question likely to result in retrieving accurate embedding chunks from the vector database, resulting in a more precise response.

Through empirical evaluation and case studies, an effectiveness of the inventive scoring mechanism in guiding users to frame better questions for RAG systems has been demonstrated, which contributes to enhancing the usability and performance of RAG systems by providing users with actionable insights into question framing, ultimately leading to improved retrieval and response accuracy.

This novel scoring system is designed to address the challenge of question framing in RAG systems, where users lack a clear understanding of the underlying data in the vector database. By providing a score, users can determine whether the framed questions are optimal for retrieving accurate information, which improves an overall performance of the RAG system.

The inventive scoring mechanism provided by embodiments of the present invention is a significant departure from current practice in existing RAG systems which primarily focus on optimizing the retrieval process and devising metrics for evaluating performance. Introducing the inventive scoring mechanism for evaluating the effectiveness of framed questions enhances usability and performance of RAG systems.

Retrieval Argument Generation (RAG) systems have become increasingly popular in recent years, with the widespread implementation of Large Language Models (LLMs) across various enterprises. RAG systems enable users to ask questions and receive accurate responses based on information retrieved from a vector database. However, an effectiveness of RAG systems heavily relies on a quality of the embeddings retrieved from the vector database, which in turn depends on the user's ability to frame optimal questions.

Despite the advancements in RAG systems and the development of various evaluation metrics, the challenge of question framing remains unresolved. Users often struggle to determine whether the framed questions by the users are optimal for retrieving accurate information from the vector database. The lack of mechanisms to evaluate question framing leads to poor retrieval and response accuracy, negatively impacting the overall performance of RAG systems.

Moreover, users may not be familiar with the underlying data's keywords or terminology, leading to suboptimal questions that fail to retrieve accurate embeddings, which highlights a need for a scoring mechanism that can guide users in framing better questions, ultimately improving retrieval and response accuracy.

Therefore, there is a critical need for a scoring mechanism that can evaluate the effectiveness of framed questions in RAG systems. Such a mechanism, which is provided by embodiments of the present invention, provides users with actionable insights into question framing, enabling users to ask better questions and to retrieve more accurate embeddings from the vector database. Embodiments of the present invention provide a novel scoring mechanism for evaluating the effectiveness of framed questions in RAG systems, which enhances usability and performance of RAG systems.

An inventive solution provided by embodiments of the present invention enhances an effectiveness of Retrieval Argument Generation (RAG) systems by introducing a novel scoring mechanism for evaluating the quality of framed questions. The inventive solution comprises several key components, including document chunking, embedding generation, vector database creation, and a scoring calculation.

First, the input documents are split into smaller chunks, allowing the LLM model to generate sample questions related to each chunk. These questions are then converted into embeddings and stored in a vector database.

In response to an end user posing a question, the system retrieves the closest related embeddings from the vector database and, in one embodiment, calculates Rouge metrics for each of the top 3 questions against the user's question. The average of these Rouge metrics serves as a final score, indicating the coverage of the user's question with respect to the underlying dataset.

The inventive scoring mechanism provides actionable insights to end users, guiding the users to frame better questions for RAG systems, which leads to improved retrieval and response accuracy, enhancing the overall usability and performance of RAG systems.

The inventive solution is not limited to specific types of documents or LLM models, making the solution widely applicable across various domains and use cases. By addressing a challenge of question framing in RAG systems, this solution contributes to the advancement of large language models and practical applications of the large language models in real-world scenarios.

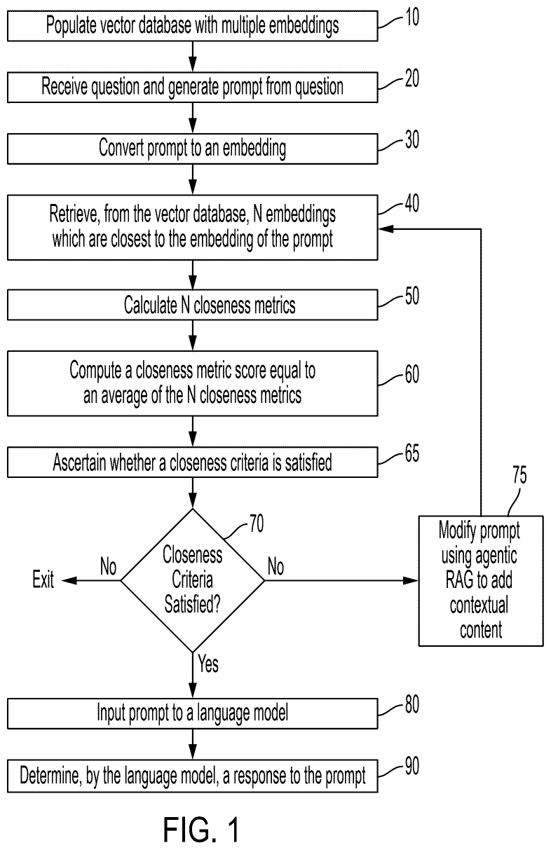

FIG. 1 is a flow chart of first embodiment of a method for question framing evaluation using a vector database, in accordance with embodiments of the present invention. The method of FIG. 1 includes steps 10-90.

Step 10 populates a vector database with multiple embeddings. Each embedding of the multiple embeddings in the vector database is an embedding of a question relating to a chunk of multiple chunks of one or more documents. Each chunk of each document is text selected from the group consisting of one or more paragraphs, one or more pages, one or more sections, one or more sentences, or a combination thereof, of each document. An embedding is a vector of real numbers that represent the chunk.

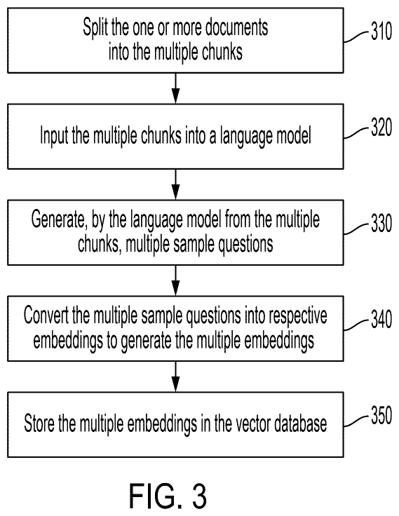

Step 10 is described infra in greater detail in FIG. 3.

Step 20 receives a question and generates a prompt from the question. In one embodiment, the question received in step 20 originates from a user. In another embodiment, the question received in step 20 originates from a software program that generates the question.

Step 30 converts the prompt to an embedding. The question is in a text format.

Step 40 retrieves, from the vector database, N embeddings which are closest to the embedding of the prompt, wherein N is at least 2. The vector database includes the multiple embeddings that populated the vector database in step 10.

Step 40 uses a measure of similarity of the embedding of the prompt to each embedding of the N embeddings to determine the N closest embeddings that have the highest similarities, wherein the measure of similarity may be, inter alia, cosine similarity, Euclidean distance, dot product similarity, Manhattan distance (alco called L1 norm), Jaccard similarity, Hamming distance, etc.

Step 50 calculates N closeness metrics, wherein each closeness metric is a measure of a closeness of the prompt to a respective question associated with each embedding of the N embeddings. The closeness metric may be, inter alia, a Rouge score, a Bleu score, etc. If the closeness metric is a Rouge score, then the Rouge score may be any known Rouge score such as, inter alia, a Rouge-N score which matches n-grams between the prompt and the question associated with each embedding of the N embeddings, a Rouge-L score which is based on a longest common subsequence (LCS), a Rouge-S score which is skip-gram concurrence metric, etc.

Step 60 computes a closeness metric score equal to an average of the N closeness metrics. The average may be, inter alia, an arithmetic average, a geometric average, etc.

Step 70 ascertains whether a closeness criteria is satisfied, wherein the closeness criteria comprises the closeness metric score being equal to or greater than a specified closeness metric score threshold. In one embodiment, the closeness metric score threshold is in a range of 0.70-0.80 (e.g., 0.75).

In one embodiment, the closeness criteria further comprises a variance of the N closeness metrics being less than a specified closeness metric variance threshold

If step 70 ascertains that that the closeness criteria is satisfied, then steps 80 and 90 are next performed.

Step 80 inputs the prompt to a language model. The language model is a machine learning-based artificial intelligence model that predicts or generates text based on learned relationships in text data. The language model may include, inter alia, large language models (LLMs), neural language models (NLMs), etc.

In step 90, the language model determines and outputs a response to the prompt.

If step 70 ascertains that that the closeness criteria is not satisfied, then either the method is exited in one embodiment or an iterative process is performed, using loop 77, in another embodiment. Each iteration of the iterative process comprises: modifying the prompt in step 75 followed by retrieving the N embeddings in step 40, calculating the N closeness metrics in step 50, computing the closeness metric score in step 60, and ascertaining the closeness criteria is satisfied in step 70. Successive iterations may include interacting with the user, or using a conversational history with the user, to determine how to improve the closeness metric calculated in step 60. In one embodiment the conversational history includes content specified by the user to determine embeddings to extract from the vector database to provide context to add to the prompt.

Step 75 modifies the prompt via one or more artificial intelligence (AI) agents of an agentic Retrieval Augmented Generation (RAG) analyzing the multiple embeddings in the vector database in relation to the question to determine contextual content relating to the question and to modify the prompt based on the contextual content.

Retrieval Augmented Generation (RAG) modifies a prompt inputted to a language model (LM), such as inter alia a large language model (LLM), so that the language model responds to the prompt with contextual content obtained from a set of specific-purpose documents to augment information obtained from the LM's own training data, which allows the LM to generate a response to the prompt using narrowly tailored and/or updated information. In one embodiment, the contextual content is obtained from the multiple embeddings in the vector database.

Agentic RAG is used in step 75 to enhance RAG by using one or more artificial intelligence (AI) agents to interact with and analyze the multiple embeddings in the vector database to determine contextual content relating to the question and modify the prompt based on the contextual content. The one or more AI agents need not be trained.

In one embodiment, ordinary RAG or agentic RAG can be used to identify specialized databases, in addition to the vector database, to obtain information on particular subjects which are relevant to the user's question and which may be used to modify the prompt.

The iterative process ends in response to either ascertaining that the closeness metric is satisfied (Yes branch from step 70) or that a specified maximum number of iterations has been performed.

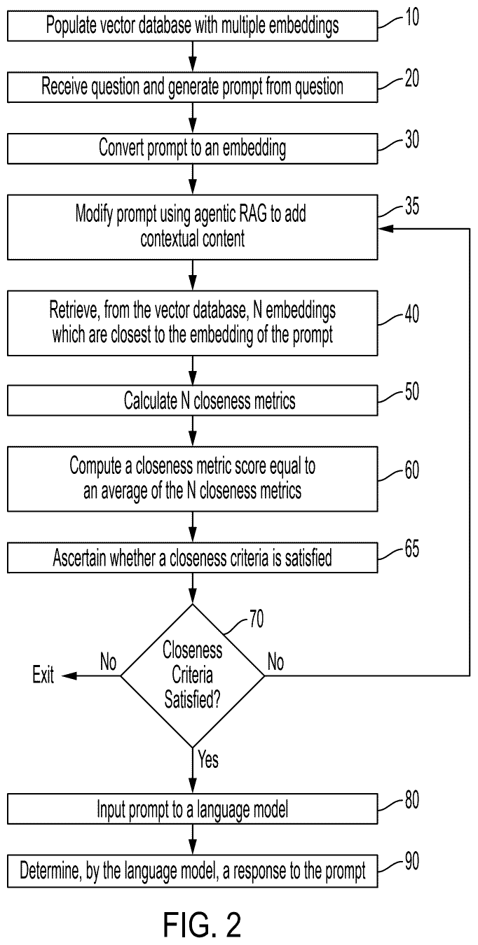

FIG. 2 is a flow chart of a second embodiment of a method for question framing evaluation using a vector database, in accordance with embodiments of the present invention. The method of FIG. 2 includes steps 10-90.

The methods of FIGS. 1 and 2 differ in that the method of FIG. 2 includes step 35 but not step 75, and the method in FIG. 1 includes step 75 but not step 35. Steps 35 and 75 each invoke agentic RAG to modify the prompt generated from the question received in step 20.

Step 10 populates a vector database with multiple embeddings. Each embedding of the multiple embeddings in the vector database is an embedding of a question relating to a chunk of multiple chunks of one or more documents. Each chunk of each document is text selected from the group consisting of one or more paragraphs, one or more pages, one or more sections, one or more sentences, or a combination thereof, of each document. An embedding is a vector of real numbers that represent the chunk.

Step 10 is described infra in greater detail in FIG. 3.

Step 20 receives a question and generates a prompt from the question. In one embodiment, the question received in step 20 originates from a user. In another embodiment, the question received in step 20 originates from a software program that generates the question.

The prompt, which is in a text format, may be generated from the question by cleaning up the question (e.g., by removing extraneous characters, correcting typos, standardizing formatting, etc.), making structural changes (e.g., being restructured to fit a more formal query style or to align with a specific prompting template), etc.

Step 30 converts the prompt to an embedding. The question is in a text format.

Step 35 modifies the prompt via one or more artificial intelligence (AI) agents of an agentic Retrieval Augmented Generation (RAG) analyzing the multiple embeddings in the vector database in relation to the question to determine contextual content relating to the question and to modify the prompt based on the contextual content.

Retrieval Augmented Generation (RAG) modifies a prompt inputted to a language model (LM), such as inter alia a large language model (LLM), so that the language model responds to the prompt with contextual content obtained from a set of specific-purpose documents to augment information obtained from the LM's own training data, which allows the LM to generate a response to the prompt using narrowly tailored and/or updated information. In one embodiment, the contextual content is obtained from the multiple embeddings in the vector database.

Agentic RAG is used in step 35 to enhance RAG by using one or more artificial intelligence (AI) agents to interact with and analyze the multiple embeddings in the vector database to determine contextual content relating to the question and modify the prompt based on the contextual content. The one or more AI agents need not be trained.

In one embodiment, ordinary RAG or agentic RAG can be used to identify specialized databases, in addition to the vector database, to obtain information on particular subjects which are relevant to the user's question and which may be used to modify the prompt.

Step 40 retrieves, from the vector database, N embeddings which are closest to the embedding of the prompt, wherein N is at least 2. The vector database includes the multiple embeddings that populated the vector database in step 10.

Step 40 uses a measure of similarity of the embedding of the prompt to each embedding of the N embeddings to determine the N closest embeddings that have the highest similarities, wherein the measure of similarity may be, inter alia, cosine similarity, Euclidean distance, dot product similarity, Manhattan distance (alco called L1 norm), Jaccard similarity, Hamming distance, etc.

Step 50 calculates N closeness metrics, wherein each closeness metric is a measure of a closeness of the prompt to a respective question associated with each embedding of the N embeddings. The closeness metric may be, inter alia, a Rouge score, a Bleu score, etc. If the closeness metric is a Rouge score, then the Rouge score may be any known Rouge score such as, inter alia, a Rouge-N score which matches n-grams between the prompt and the question associated with each embedding of the N embeddings, a Rouge-L score which is based on a longest common subsequence (LCS), a Rouge-S score which is skip-gram concurrence metric, etc.

Step 60 computes a closeness metric score equal to an average of the N closeness metrics. The average may be, inter alia, an arithmetic average, a geometric average, etc.

Step 70 ascertains whether a closeness criteria is satisfied, wherein the closeness criteria comprises the closeness metric score being equal to or greater than a specified closeness metric score threshold. In one embodiment, the closeness metric score threshold is in a range of 0.70-0.80 (e.g., 0.75).

In one embodiment, the closeness criteria further comprises a variance of the N closeness metrics being less than a specified closeness metric variance threshold

If step 70 ascertains that that the closeness criteria is satisfied, then steps 80 and 90 are next performed.

Step 80 inputs the prompt to a language model. The language model is a machine learning-based artificial intelligence model that predicts or generates text based on learned relationships in text data. The language model may include, inter alia, large language models (LLMs), neural language models (NLMs), etc.

In step 90, the language model determines and outputs a response to the prompt.

If step 70 ascertains that that the closeness criteria is not satisfied, then either the method is exited in one embodiment or an iterative process is performed, using loop 78, in another embodiment. Each iteration of the iterative process comprises: modifying the prompt in step 35 followed by retrieving the N embeddings in step 40, calculating the N closeness metrics in step 50, computing the closeness metric score in step 60, and ascertaining the closeness criteria is satisfied in step 75. Successive iterations may include interacting with the user, or using a conversational history with the user, to determine how to improve the closeness metric calculated in step 60. In one embodiment the conversational history includes content specified by the user to determine embeddings to extract from the vector database to provide context to add to the prompt.

FIG. 3 is a flow chart of a process for populating the vector database with the multiple embeddings, in accordance with embodiments of the present invention. The process of FIG. 3, which includes steps 310-350, describes stem 10 of FIG. 1 in greater detail.

Step 310 splits the one or more documents into the multiple chunks.

Step 320 inputs the multiple chunks into a language model.

Step 330 generates, by the language model from the multiple chunks, multiple sample questions. One or more questions are generated by the language model for each chunk.

Step 340 converts the multiple sample questions into respective embeddings to generate the multiple embeddings.

Step 350 stores the multiple embeddings in the vector database.

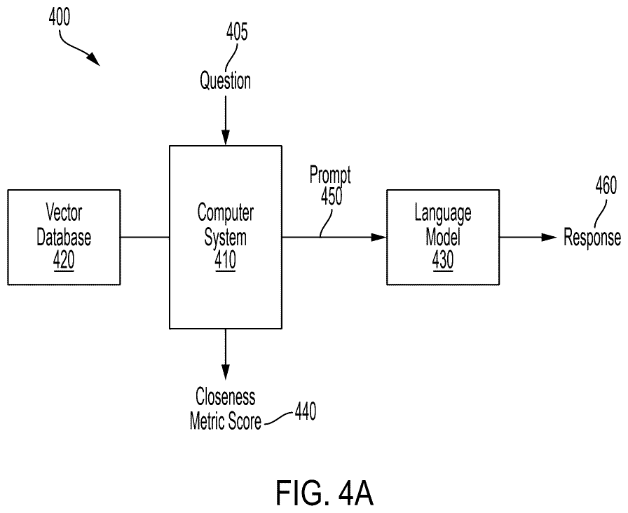

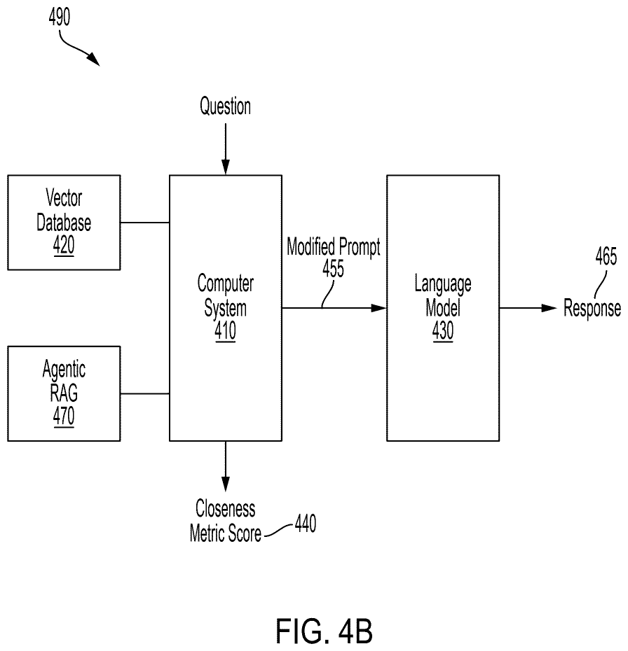

FIG. 4A depicts a first computer architecture 400 for implementing the method of FIGS. 1 and 2, in accordance with embodiments of the present invention.

A computer system 410 is coupled to a vector database 420 and a language model 430.

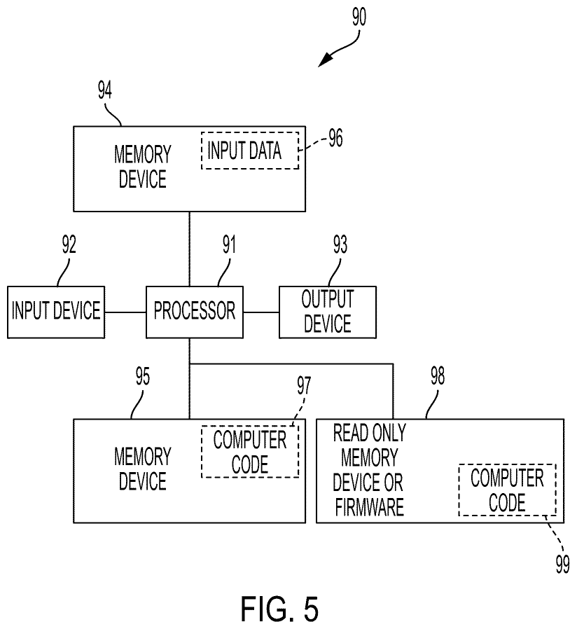

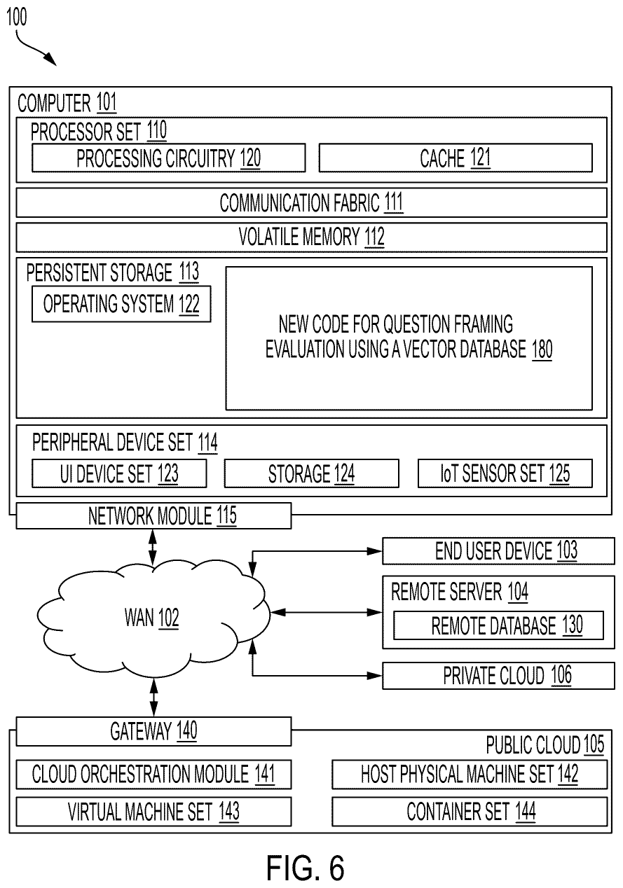

The computer system 410 may be the computer system 90 of FIG. 5 or the computing environment 100 of FIG. 6.

The vector database 420 is populated with multiple embeddings via execution of step 10 in FIG. 1 or FIG. 2.

The computer system 410 receives a question 405 and generates a prompt 450 via execution of step 20 of FIG. 1 or FIG. 2

The computer system 410 computes a closeness metric score 440 via execution of step 60 in FIG. 1 or FIG. 2.

The computer system 410 inputs the prompt 450 to the language model 430 which generates a response 460.

FIG. 4B depicts a second computer architecture 490 for implementing the method of FIGS. 1 and 2, in accordance with embodiments of the present invention.

The computer system 410 is coupled to the vector database 420, the language model 430, and an agentic RAG 460.

The second computer architecture 490 differs from the first computer architecture 400 in that the second computer architecture 490 additionally includes the agentic RAG 470 resulting in a modified prompt 455 (instead of the prompt 450 in the first computer architecture 400) via execution of step 75 in FIG. 1 or step 35 in FIG. 2.

The computer system 410 inputs the modified prompt 455 to the language model 430 which generates a response 465.

FIG. 5 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 5 shows the computer system 90 as a particular configuration of hardware and software, any configuration of hardware and software, as would be known to a person of ordinary skill in the art, may be utilized for the purposes stated supra in conjunction with the particular computer system 90 of FIG. 5. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 6 depicts a computing environment 100 which contains an example of an environment for the execution of at least some of the computer code involved in performing the inventive methods, in accordance with embodiments of the present invention. Such computer code includes new code for question framing evaluation using a vector database 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for question framing evaluation using a vector database, comprising:
receiving, by one or more processors of a computer system, a question;
generating, by the one or more processors, a prompt from the question;
converting, by the one or more processors, the prompt to an embedding;
modifying, by the one or more processors, the prompt via one or more artificial intelligence (AI) agents of an agentic Retrieval Augmented Generation (RAG) analyzing multiple embeddings in the vector database in relation to the question to determine contextual content relating to the question and modifying the prompt based on the contextual content;
retrieving, by the one or more processors from the vector database, N embeddings which are closest to the embedding of the prompt, wherein N is at least 2, and wherein each embedding of the multiple embeddings in the vector database is an embedding of a question relating to a chunk of multiple chunks of one or more documents;
calculating, by the one or more processors, N closeness metrics, wherein each closeness metric is a measure of a closeness of the prompt to a respective question associated with each embedding of the N embeddings;
computing, by the one or more processors, a closeness metric score equal to an average of the N closeness metrics;
ascertaining, by the one or more processors, whether a closeness criteria is satisfied, wherein the closeness criteria comprises the closeness metric score being equal to or greater than a specified closeness metric score threshold; and
if said ascertaining ascertains that the closeness criteria is satisfied, then inputting, by the one or more processors, the prompt to a language model followed by the language model determining and outputting, using the one or more processors, a response to the prompt.

2. (canceled)

3. The method of claim 1,
wherein if said ascertaining ascertains that the closeness criteria is not satisfied then exiting the method or performing an iterative process in which each iteration of the iterative process comprises: executing said modifying the prompt, said retrieving the N embeddings, said calculating the N closeness metrics, said computing the closeness metric score, and said ascertaining, wherein the iterative process ends in response to either ascertaining that the closeness metric is satisfied or a specified maximum number of iterations has been performed.

4. The method of claim 3, wherein the closeness criteria further comprises a variance of the N closeness metrics being less than a specified closeness metric variance threshold.

5. The method of claim 1,
wherein if said ascertaining ascertains that the closeness criteria is not satisfied then exiting the method or performing an iterative process in which each iteration of the iterative process comprises:
further modifying the prompt, followed by executing said retrieving the N embeddings, said calculating the N closeness metrics, said computing the closeness metric score, and said ascertaining, wherein the iterative process ends in response to either ascertaining that the closeness metric is satisfied or a specified maximum number of iterations has been performed.

6. The method of claim 5, wherein the closeness criteria further comprises a variance of the N closeness metrics being less than a specified closeness metric variance threshold.

7. The method of claim 1, said method further comprising: prior to said receiving the question, populating, by the one or more processors, the vector database with the multiple embeddings, wherein said populating the vector database comprises:
splitting the one or more documents into the multiple chunks;
inputting the multiple chunks into a language model;
generating, by the language model from the multiple chunks, multiple sample questions;
converting the multiple sample questions into respective embeddings to generate the multiple embeddings; and
storing the multiple embeddings in the vector database.

8. The method of claim 1, wherein each chunk of each document is text selected from the group consisting of one or more paragraphs, one or more pages, one or more sections, one or more sentences, or a combination thereof, of said each document.

9. A computer program product, comprising one or more computer readable storage media storing computer readable program instructions, said program instructions executable by one or more processors of a computer system to cause the computer system to perform operations for question framing evaluation using a vector database, said operations comprising:
receiving a question;
generating a prompt from the question;
converting the prompt to an embedding;
modifying the prompt via one or more artificial intelligence (AI) agents of an agentic Retrieval Augmented Generation (RAG) analyzing multiple embeddings in the vector database in relation to the question to determine contextual content relating to the question and modifying the prompt based on the contextual content;
retrieving, from the vector database, N embeddings which are closest to the embedding of the prompt, wherein N is at least 2, and wherein each embedding of the multiple embeddings in the vector database is an embedding of a question relating to a chunk of multiple chunks of one or more documents;
calculating N closeness metrics, wherein each closeness metric is a measure of a closeness of the prompt to a respective question associated with each embedding of the N embeddings;
computing a closeness metric score equal to an average of the N closeness metrics; and
ascertaining whether a closeness criteria is satisfied, wherein the closeness criteria comprises the closeness metric score being equal to or greater than a specified closeness metric score threshold;
if said ascertaining ascertains that the closeness criteria is satisfied, then inputting the prompt to a language model followed by the language model determining and outputting a response to the prompt.

10. (canceled)

11. The computer program product of claim 9,
wherein if said ascertaining ascertains that the closeness criteria is not satisfied then exiting a method or performing an iterative process in which each iteration of the iterative process comprises: executing said modifying the prompt, said retrieving the N embeddings, said calculating the N closeness metrics, said computing the closeness metric score, and said ascertaining, wherein the iterative process ends in response to either ascertaining that the closeness metric is satisfied or a specified maximum number of iterations has been performed.

12. The computer program product of claim 9,
wherein if said ascertaining ascertains that the closeness criteria is not satisfied then exiting a method or performing an iterative process in which each iteration of the iterative process comprises:
further modifying the prompt, followed by executing said retrieving the N embeddings, said calculating the N closeness metrics, said computing the closeness metric score, and said ascertaining, wherein the iterative process ends in response to either ascertaining that the closeness metric is satisfied or a specified maximum number of iterations has been performed.

13. A computer system, comprising one or more processors, one or more memories, one or more computer readable storage media, and computer readable program instructions stored on the one or more computer readable storage media for execution by the one or more processors via the one or more memories to cause the computer system to perform operations for question framing evaluation using a vector database, said operations comprising:
receiving a question;
generating a prompt from the question;
converting the prompt to an embedding;
modifying the prompt via one or more artificial intelligence (AI) agents of an agentic Retrieval Augmented Generation (RAG) analyzing multiple embeddings in the vector database in relation to the question to determine contextual content relating to the question and modifying the prompt based on the contextual content;
retrieving, from the vector database, N embeddings which are closest to the embedding of the prompt, wherein N is at least 2, and wherein each embedding of the multiple embeddings in the vector database is an embedding of a question relating to a chunk of multiple chunks of one or more documents;
calculating N closeness metrics, wherein each closeness metric is a measure of a closeness of the modified prompt to a respective question associated with each embedding of the N embeddings;
computing a closeness metric score equal to an average of the N closeness metrics; and
ascertaining whether a closeness criteria is satisfied, wherein the closeness criteria comprises the closeness metric score being equal to or greater than a specified closeness metric score threshold;
if said ascertaining ascertains that the closeness criteria is satisfied, then inputting the prompt to a language model followed by the language model determining and outputting a response to the prompt.

14. (canceled)

15. The computer system of claim 13,
wherein if said ascertaining ascertains that the closeness criteria is not satisfied then exiting a method or performing an iterative process in which each iteration of the iterative process comprises: executing said modifying the prompt, said retrieving the N embeddings, said calculating the N closeness metrics, said computing the closeness metric score, and said ascertaining, wherein the iterative process ends in response to either ascertaining that the closeness metric is satisfied or a specified maximum number of iterations has been performed.

16. The computer system of claim 13,
wherein if said ascertaining ascertains that the closeness criteria is not satisfied then exiting a method or performing an iterative process in which each iteration of the iterative process comprises:
further modifying the prompt, followed by executing said retrieving the N embeddings, said calculating the N closeness metrics, said computing the closeness metric score, and said ascertaining, wherein the iterative process ends in response to either ascertaining that the closeness metric is satisfied or a specified maximum number of iterations has been performed.

17. A method for question framing evaluation using a vector database, said method comprising:
splitting, by one or more processors of a computer system, one or more documents into multiple chunks;
inputting, by the one or more processors, the multiple chunks into a language model;
generating, by the language model from the multiple chunks using the one or more processors, multiple sample questions;
converting, by the one or more processors, the multiple sample questions into respective embeddings to generate multiple embeddings;
storing, by the one or more processors, the multiple embeddings in the vector database;
receiving, by one or more processors, a question;
generating, by the one or more processors, a prompt from the question;
converting, by the one or more processors, the prompt to an embedding;
modifying, by the one or more processors, the prompt by a Retrieval Augmented Generation (RAG) or an agentic RAG, wherein said modifying the prompt comprises modifying the prompt by one or more artificial intelligence (AI) agents of the agentic RAG via the one or more AI agents analyzing the multiple embeddings in the vector database in relation to the question to determine contextual content relating to the question and modifying the prompt based on the contextual content;
retrieving, by the one or more processors from the vector database, N embeddings which are closest to the embedding of the modified prompt, wherein N is at least 2, wherein the vector database includes multiple embeddings, and wherein each embedding of the multiple embeddings in the vector database is an embedding of a question relating to a chunk of multiple chunks of one or more documents;
calculating, by the one or more processors, N closeness metrics, wherein each closeness metric is a measure of a closeness of the modified prompt to a respective question associated with each embedding of the N embeddings;
computing, by the one or more processors, a closeness metric score equal to an average of the N closeness metrics;
inputting, by the one or more processors, the modified prompt to a language model; and
determining and outputting, by the language model using the one or more processors, a response to the prompt, said response based on the modified prompt.

18. (canceled)

19. The method of claim 17, wherein said modifying the prompt further comprises modifying the prompt by RAG via identifying a specialized database, obtaining from the specialized database information on a particular subject which is relevant to the question, and using the information to modify the prompt.

20. The method of claim 17, wherein the language model is a large language model (LLM).

21. (canceled)

22. A computer program product, comprising one or more computer readable storage media storing computer readable program instructions, said program instructions executable by one or more processors of a computer system to cause the computer system to perform operations for question framing evaluation using a vector database, said operations comprising:
splitting, by one or more processors of a computer system, one or more documents into multiple chunks;
inputting the multiple chunks into a language model;
generating, by the language model from the multiple chunks, multiple sample questions;
converting, by the one or more processors, the multiple sample questions into respective embeddings to generate multiple embeddings;
storing the multiple embeddings in the vector database;
receiving a question;
generating a prompt from the question;
converting the prompt to an embedding;
modifying the prompt by a Retrieval Augmented Generation (RAG) or an agentic RAG, wherein said modifying the prompt comprises modifying the prompt by one or more artificial intelligence (AI) agents of the agentic RAG via the one or more AI agents analyzing the multiple embeddings in the vector database in relation to the question to determine contextual content relating to the question and modifying the prompt based on the contextual content;
retrieving, from the vector database, N embeddings which are closest to the embedding of the modified prompt, wherein N is at least 2, wherein the vector database includes multiple embeddings, and wherein each embedding of the multiple embeddings in the vector database is an embedding of a question relating to a chunk of multiple chunks of one or more documents;
calculating N closeness metrics, wherein each closeness metric is a measure of a closeness of the prompt to a respective question associated with each embedding of the N embeddings;
computing a closeness metric score equal to an average of the N closeness metrics;
inputting, by the one or more processors, the modified prompt to a language model; and
determining and outputting, by the language model using the one or more processors, a response to the prompt, said response based on the modified prompt.

23. (canceled)

24. The computer program product of claim 22, wherein said modifying the prompt further comprises modifying the prompt by RAG via identifying a specialized database, obtaining from the specialized database information on a particular subject which is relevant to the question, and using the information to modify the prompt.

25. The computer program product of claim 22, wherein the language model is a large language model (LLM).
